(19) United States
(12) Patent Application Publication
(10) Pub. No.: US 2010/0002941 A1
(43) Pub. Date: Jan. 7, 2010

(54) METHOD AND APPARATUS FOR IDENTIFYING AN OBJECT CAPTURED BY A DIGITAL IMAGE

(75) Inventors: Pedro Fonseca, Eindhoven (NL); Marc Andre Peters, Eindhoven (NL); Yuechen Qian, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS N.V., EINDHOVEN (NL)

(21) Appl. No.: 12/514,145

(22) PCT Filed: Nov. 9, 2007
(86) PCT No.: PCT/IB07/54568

§ 371 Date: May 8, 2009

(30) Foreign Application Priority Data
Nov. 14, 2006 (EP) 06124015.6

(51) Int. Cl. G06K 9/62

(52) U.S. Cl. 382/209

(57) ABSTRACT

An object captured by a digital image is automatically identified by determining a location at which a digital image is captured; retrieving a plurality of candidate objects associated with said determined location; comparing an object captured by said digital image with each of said retrieved plurality of candidate objects to identify said object. One of the candidate images can be selected and used to create a collage of the captured image and a more complete image of the object.

### FIELD OF THE INVENTION

The present invention relates to a method and apparatus for identifying an object captured by a digital image.

### BACKGROUND OF THE INVENTION

The main drawback of existing image management solutions is related to the lack of tools that allow the automatic or even semi-automatic annotation of digital image. With the near exponential growth in the amount of digital images captured everyday, advanced solutions are needed to properly manage and annotate these images and, at the same time, take advantage of the growing popularity of online photo management solutions.

Many management solutions exists, for example U.S. 2002/0071677 in which the location where the image is captured is used to retrieve descriptive data about the image. However, the system is unable to identify the subject of the image accurately from location alone in the event that more than one object is at that location. WO 03/052508 is an example of a system which automatically annotates/tags images using location data as a tag and also includes an image analyzer to recognize objects captured by the image. Such image analyzers are often complex and slow in processing images.

Another problem is when the user wishes to compose an image having in the foreground a smaller object, for example one or more persons, and a larger object for example a building in the background. Often the object in the background is too big to be captured in a single image, due to the range or limits allowed by the capturing device in which case the user captures several images of a scene and later stitches them together into a collage on a computer at home.

Known software tools, such as like PTGui and PhotoStitch, provide assistance to the user in creating a collage. In general they operate as follows. First, the user selects multiple images of an attraction. Second, the user lays out the images using the tool. Third, the tool identifies the overlapping areas of every two adjacent images. Fourth, the tool smoothes the overlapping areas by panning, scaling, rotating, brightness/contrast adjustment etc. Finally, the tool crops a collage image out of the stitched images.

However, the problems encountered by such tools are that when adjacent images have insufficient overlapping areas, either shifted or not captured at all it is difficult for the tools to automatically align the images and the user is often asked to manually define the overlapping area, which is prone to errors. Further, the images used for stitching can be taken by different zoom settings and the differences in depth-of-view during image capturing are difficult to be remedied during image stitching. Further, the images that were taken using a wide-angle lens cause distortions in perspective, which are also very difficult to be corrected during stitching.

### SUMMARY OF THE INVENTION

The present invention seeks to provide a simplified, faster system for automatically and accurately identifying an object captured by a digital image on the basis of location data for automatic annotation of the digital image and for stitching images to create a collage.

This is achieved according to an aspect of the present invention by a method of identifying an object captured by a digital image, the method comprising the steps of: determining a location at which a digital image is captured; retrieving a plurality of candidate objects associated with the determined location; comparing an object captured by the digital image with each of the retrieved plurality of candidate objects to identify the object.

This is also achieved according to another aspect of the present invention by apparatus for identifying an object captured by a digital image, the apparatus comprising: means for determining a location at which a digital image is captured; means for retrieving a plurality of candidate objects associated with the determined location; a comparator for comparing an object captured by the digital image with each of the retrieved plurality of candidate objects to identify the object.

Therefore a simplified system is used to identify an object captured by a digital image in that the location determined when the image is captured is used to limit the candidate objects to those associated with that location and making a comparison with these selected candidate objects making the process accurate and faster.

The comparison may be simply achieved by comparison of digital images containing an object associated with the determined location. Once the object has been identified, additional metadata associated with the object may be retrieved from different sources and attached to the image.

Further information, such as weather, time and date may be collected when the image is captured and may be taken in consideration when comparing the object to improve accuracy of identification of the object.

Furthermore, to improve accuracy, the captured image may be added to the database of images from which candidate image are selected.

The location may be determined by GPS or by triangulation with transceivers or base stations in the case of a cellular telephone having an integral camera.

A candidate image can be selected which captures the identified object and features of the object can be matched to stitch the candidate image and the digital image to create a collage.

### BRIEF DESCRIPTION OF DRAWINGS

For a more complete understanding of the present invention, reference is now made to the following description taken in conjunction with the accompanying drawings in which:

FIG. 1 is a simplified schematic diagram of the apparatus according to an embodiment of the present invention;

FIG. 2 is an example of the steps of selection of candidate objects according to the embodiment of the present invention; and

FIG. 3 is an example of supplementing metadata with additional data upon identification according to the embodiment of the present invention.

FIGS. 4, 5, 6(a), 6(b) and 6(c) illustrate a further embodiment of the present invention in which an object identified is used to create a collage;

FIG. 7 illustrates creating the collage on the image-capturing device instead of remotely on a server;

FIGS. 8(a), 8(b), 8(c) and 8(d) illustrate the steps of creating a collage according to a second embodiment of the present invention.

### DETAILED DESCRIPTION OF AN EMBODIMENT OF THE INVENTION

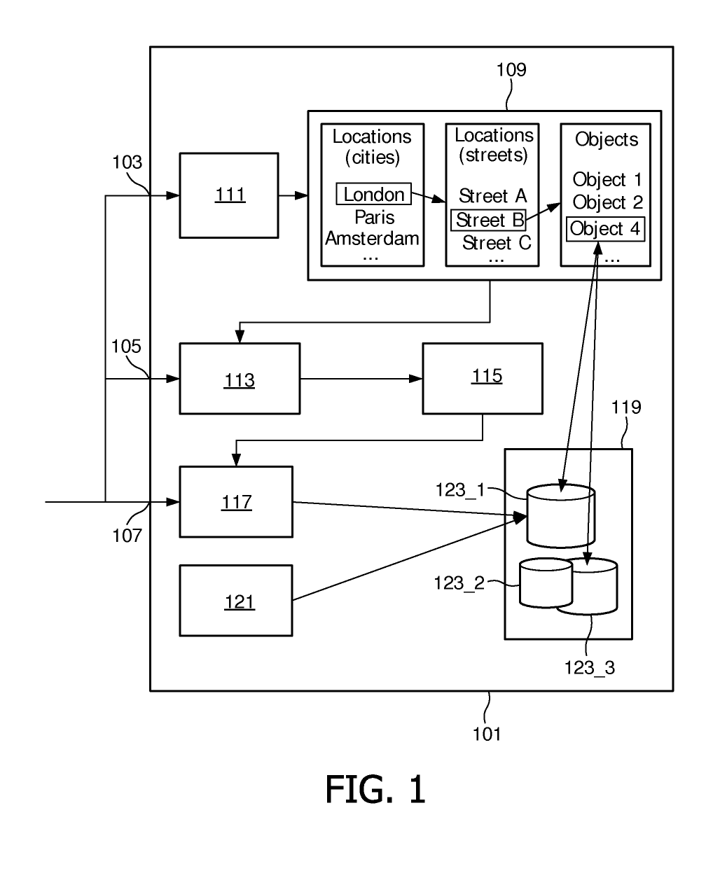

With reference to FIG. 1, the apparatus comprises a server 101. The server 101 comprises a first, second and third input terminals 103, 105, 107. The first input terminal 103 is connected to a candidate database 109 via an interface 111. The output of the candidate database 109 is connected to an object identification unit 113. The object identification unit 113 is also connected to the second input terminal 105 and provides an output to a retrieval unit 115. The output of the retrieval unit 115 is connected to a database editor 117. The database editor 117 is connected to the third input terminal 107. The output of the database editor 117 is connected to an image database 119. A database manager 121 is connected to the image database 119. The image database 119 comprises a plurality of user specific areas 123_1, 123_2, 123_3.

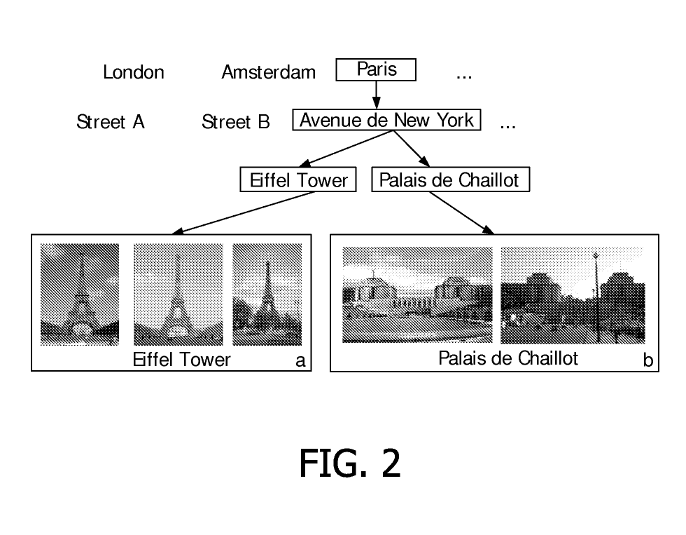

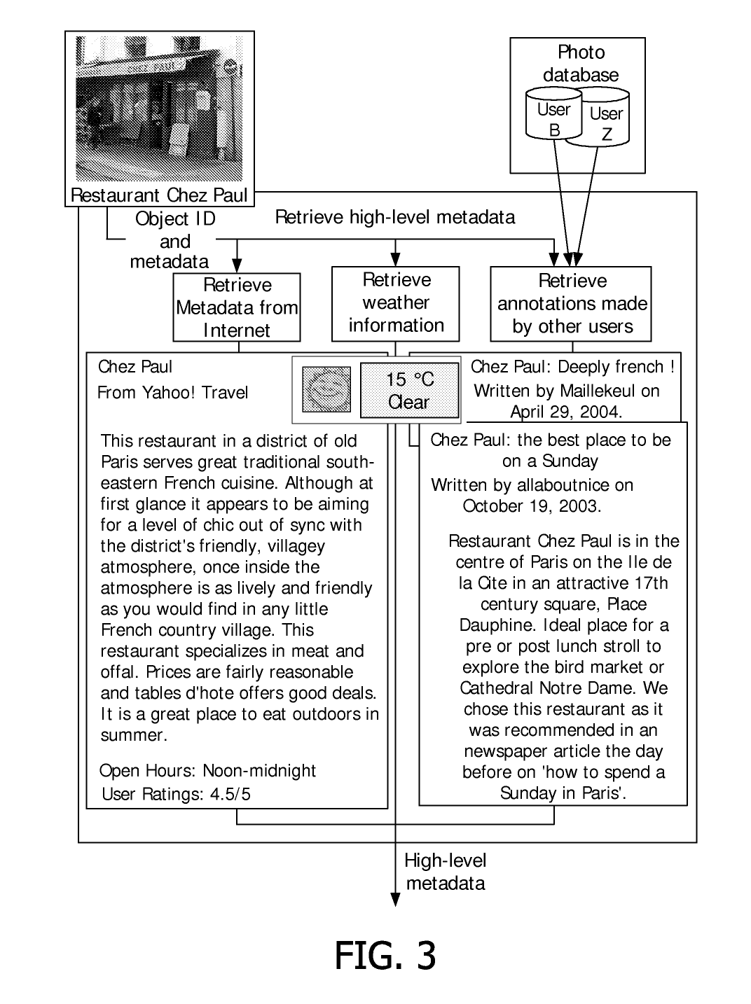

Operation of the apparatus will now be described with reference to FIGS. 2 and 3.

A digital image is captured. The image-capturing device may be a camera which is integral with a mobile telephone. As the image is captured, information such as location, time and date are collected and attached as metadata to the image. The location may be determined by well-known techniques such as, GPS or triangulation with a plurality of base stations. The location metadata is placed on the first input terminal 103, the captured image is placed on the second input terminal 105 and the image and its associated metadata, including location, is placed on the third input terminal 107.

The location metadata of the captured image is input to the candidate database 109 via the interface 111. The candidate database 109 comprises a store of a plurality of images of candidate objects and their associated location data. The candidate database 109 may be organized in many alternative ways. In one example the images are stored hierarchically by known locations, for example, countries on the first level, cities on the second, streets on the third and buildings/objects on the fourth. This organization may be particularly useful, for example, if the location information attached as metadata to the image is coarse (for example, allows the localization of the street or even the city or region where the image was taken). Alternatively, the exact geographical location may be maintained, i.e. a list of the geographical locations of all recognized objects in the database. This organization may be particularly useful if the location information is precise and will thus reduce the search space, i.e., the number of candidate objects with which recognition will be performed.

As shown in FIG. 2 a plurality of candidate objects for an image captured at the street Avenue de New York in the city of Paris are retrieved from the candidate database 109. Since from this street both the objects Eiffel Tower and Palais de Chaillot are visible, images of both objects are provided as possible candidates to the object identification unit 113.

The object identification unit 113 compares the images of the candidate objects retrieved from the candidate database 109 with the current image placed on the second input terminal 105. This may be performed with any known object recognition algorithm for example as disclosed by R. Pope, Model-based object recognition, a survey of recent research, Technical Report 94-04, Department of Computer Science, The University of British Columbia, January 1994. The object identification unit 113 outputs the identity of the object which is used by the retrieval unit 115 to access other sources to retrieve additional data associated with the identified object. The additional data (high-level metadata) may, alternatively, be manually input by the user.

The different sources accessed by the retrieval unit 115 may include Internet sources such as Wikipedia, for example, a recognized image of the Eiffel Tower may trigger retrieval from the entry Eiffel Tower in Wikipedia; Yahoo! Travel, for example, a recognized image of a restaurant may trigger retrieval of users' ratings, comments and price information on a restaurant; or Official object's website, for example, the official website of a museum may trigger retrieval of information about that museum (e.g., current exhibits, opening hours, etc). It may include sources such as collaborative annotation, in which existing annotations made manually by other users may be retrieved and attached to an image's metadata. A group of preferred users may be defined (e.g., users that participated in the same trip, friends or family, etc.) such that these annotations are retrieved only from the users of that group. Further, weather information in which weather at the capturing location, at the capturing time may be automatically retrieved from Internet weather services (for instance).

FIG. 3 illustrates the procedure through which such high-level metadata is retrieved and combined for an identified image of a restaurant. In this case, Yahoo! Travel is used to retrieve a description and rating of that restaurant and a weather Internet service used to determine the weather conditions; these would be combined with annotations and comments input by previous users and attached to the image.

The retrieved high-level metadata is output to the database editor 117. The captured image and existing metadata, such as location, date and time, placed on the high-level metadata retrieved by the retrieval unit 115 by the database editor 117 and added to the user's specific storage area 123_1 of the image database 119. Stored image may also be added to the candidate database 109 for use as a candidate object. The captured image can then be searched and retrieved from the image database 119 upon request via the database manager 121.

The performance of the apparatus and method of the embodiment of the present invention be further improved by: using precise location information since the more precise the location information (where the image was captured) is, the more precise object recognition will be. This is because the more precise the location is, the more restricted the set of candidate objects will be with which object recognition is performed. For example, if the location is provided with street-level accuracy, recognition will take place between the image and a sub-set of the database for objects (e.g., buildings) located in that same street.

Time information may be used to described objects at different times of the day; e.g., a building will look different at daytime or during the night (for instance if lights have been lit up on the building's facade). If several instances of the same object exist in the database for different time periods of the day, candidates for object identification may be chosen according to the time when the image was captured.

Date information can be used. Objects may have different appearances according to the time of the year; e.g., buildings may have special decorations during Christmas or other festivities or be covered with snow during winter. Again, if different instances of the same object exist in the database reflecting different views of the object depending on its appearance over the year, this may help improve the selection of candidates for object identification.

As mentioned above, weather information may be automatically retrieved and attached to the photo as metadata. This information may help improve object recognition in the same way as time information helps improve it: different instances of certain objects may exist in the database, according to, e.g., whether the weather is sunny or cloudy.

Furthermore, successfully identified objects may be added to the candidate database 109. This will help improve the quality of the object identification procedure over time, after images from several users have been uploaded to the candidate database 109. This is because more instances of the same object will exist and thus, the set of candidate objects for object recognition will be larger. This will also help coping with changes that the objects may be subject to over time (e.g., a part of a building may be under reconstruction or already reconstructed, or painted, or re-decorated). Objects that were incorrectly classified (or incorrectly identified by the user) will not, in principle, lower the recognition rate since if enough examples of the object exist in the database, they will be considered outliers and left out of the identification procedure.

Face detection can be used to exclude images with large faces. After determining the presence and location of faces in the images, this information may be used to prevent those images where faces occlude a large part of the object take part in the object identification procedure and being stored in the candidate database 109. Such images will not then be chosen as candidates for object identification.

The above object identification technique can be used in stitching images to create a collage and provide a more complete image.

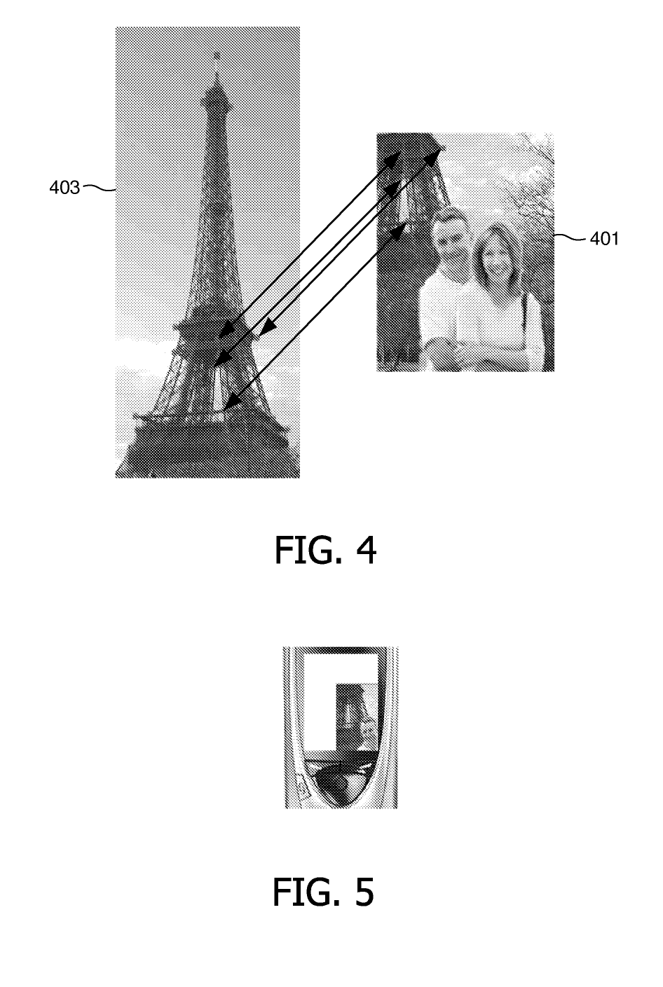

As illustrated in FIG. 4, the user selects an image 401 as the starting image for a collage. The image is sent to the server 101 of FIG. 1, for example. As described above, object recognition is performed to identify the object in the image. Then, a reference image of the identified object and its associated metadata, including feature points and exact dimensions of the object, is retrieved and sent back to the image-capturing device.

On the image-capturing device, face detection is performed to determine the location of the person(s)-of-interest. Then, the regions of the object that haven't been captured yet are determined.

The direction at which the capturing device must be pointed to in order to cover the missing regions is estimated. For each image that needs to be captured, visual aid at the borders of the display of the capturing device is provided in order to aid the user directing the capturing device. As illustrated in FIG. 5, the blank area needs to be filled in by images in order to create a complete view of the object Eiffel Tower.

The user is then simply required to direct the capturing device such that the image fits approximately the visual aid in the display as illustrated in the sequence of FIGS. 6(a), 6(b) and 6(c). This is repeated until the empty area illustrated in FIG. 5 is completed as illustrated in FIG. 6(c).

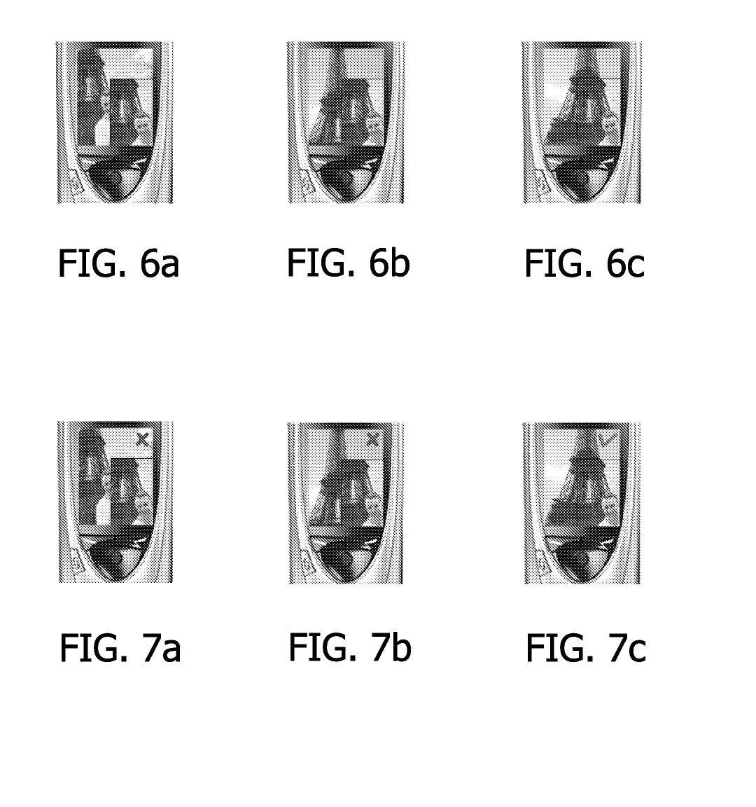

If the device has sufficient resources, the above technique can be carried out on the image-capturing device instead of remotely on the server as illustrated in FIG. 7. This helps the user to choose the next image to capture simply by displaying a visual signal that would indicate when the direction is sufficiently close to the required position.

As the process requires some seconds to be finished, after the first image has been captured, the individuals may move as long as the first image is stitched over the subsequent ones. On the other hand, even though the individuals captured in the image do not need to be static during the collage procedure, this process shouldn't take too long or natural moving objects (for example clouds) may move too much and worsen the quality of the resulting collage.

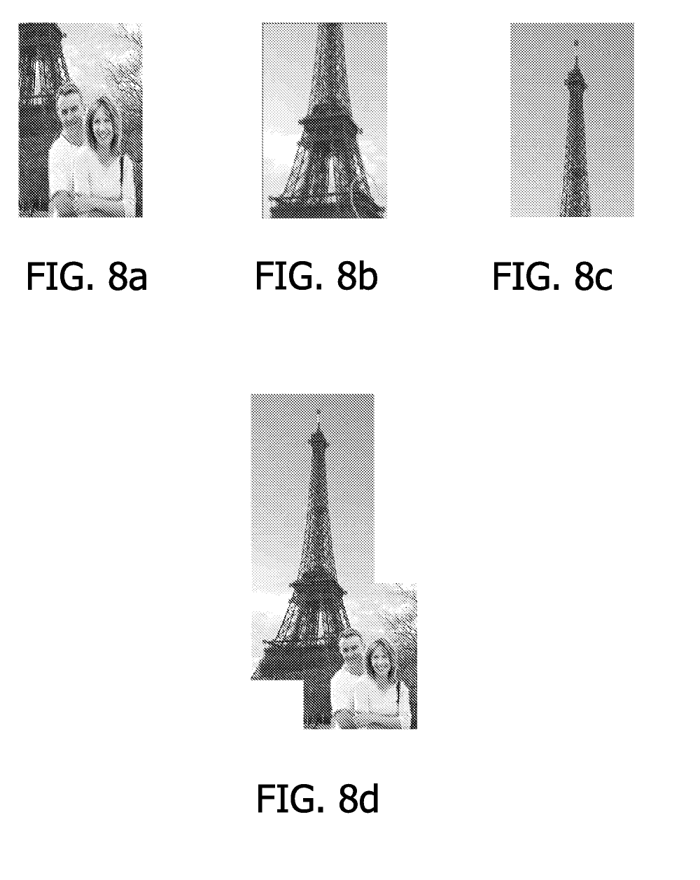

This problem can be overcome by the user selecting an image from the collection of images stored in the device as shown in FIG. 8(a). This image is then used as the starting image of a collage. The user composes and captures a second image, FIG. 8(b). The image-capturing device performs edge detection to determine the boundary of the object on the background. Therefore, in the preview display of the image-capturing device, the edge is highlighted as shown in FIG. 8(b) and furthermore the edge of the part of the object that was not captured by the image is predicted. To add images to the collage, the user focuses on a neighbor area of the previous image. The device performs in real time edge-detection and edge-matching analysis. It first detects the edge of the object in the preview display. Next it tries to find whether certain part of the edge of the object in the display matches/extends the edge of the object in the selected image of FIG. 8(a) and if so, the system will highlight the matching/extension part. With this visual guidance, the user can capture the next image.

This is then repeated and as illustrated in FIG. 8(c), a third image is captured to complete the collage as shown in FIG. 8(d)

Although preferred embodiments of the present invention have been illustrated in the accompanying drawings and described in the foregoing description, it will be understood that the invention is not limited to the embodiments disclosed but capable of numerous modifications without departing from the scope of the invention as set out in the following claims. The invention resides in each and every novel characteristic feature and each and every combination of characteristic features. Reference numerals in the claims do not limit their protective scope. Use of the verb “to comprise” and its conjugations does not exclude the presence of elements other than those stated in the claims. Use of the article “a” or “an” preceding an element does not exclude the presence of a plurality of such elements.

‘Means’, as will be apparent to a person skilled in the art, are meant to include any hardware (such as separate or integrated circuits or electronic elements) or software (such as programs or parts of programs) which perform in operation or are designed to perform a specified function, be it solely or in conjunction with other functions, be it in isolation or in co-operation with other elements. The invention can be implemented by means of hardware comprising several distinct elements, and by means of a suitably programmed computer. In the apparatus claim enumerating several means, several of these means can be embodied by one and the same item of hardware. ‘Computer program product’ is to be understood to mean any software product stored on a computer-readable medium, such as a floppy disk, downloadable via a network, such as the Internet, or marketable in any other manner.

1. A method of identifying an object captured by a digital image, the method comprising the steps of:
determining a location at which a digital image is captured;
retrieving a plurality of candidate objects associated with said determined location;
comparing an object captured by said digital image with each of said retrieved plurality of candidate objects to identify said object.

2. A method according to claim 1, wherein the step of retrieving a plurality of candidate objects comprises retrieving a plurality of candidate digital images capturing said plurality of candidate objects and the step of comparing an object captured by said digital image comprises the step of comparing said digital image with said retrieved plurality of candidate digital images.

3. A method according to claim 1, wherein the method further comprises the step of:
retrieving data associated with said identified object; and
associating said data with said digital image.

4. A method according to claim 1, wherein additional information is taken into consideration when comparing an object captured by said digital image.

5. A method according to claim 4, wherein said additional information includes information relating to weather, time and date when said digital image was captured.

6. A method according to claim 1, wherein said plurality of candidate objects are stored in a database and said identified object is added to said database.

7. A method according to claim 1, wherein the method further comprises the steps of: detecting faces in said digital image and wherein the step of comparing an object captured by said digital image comprises removing said detected face from said digital image.

8. A method according to claim 1, wherein the location comprises an address or exact geographical location.

9. A computer program product comprising a plurality of program code portions for carrying out the method according to claim 1.

10. Apparatus for identifying an object captured by a digital image, the apparatus comprising:
means for determining a location at which a digital image is captured;
means for retrieving a plurality of candidate objects associated with said determined location;
a comparator for comparing an object captured by said digital image with each of said retrieved plurality of candidate objects to identify said object.

11. Apparatus according to claim 10, wherein the apparatus further comprises storage means for storing said plurality of candidate objects.

12. Apparatus according to claim 11, wherein the apparatus further comprises:
means for updating said storage means with an object which has been identified.
